(19) United States
(12) Patent Application Publication
(10) Pub. No.: US 2005/0086822 A1
(43) Pub. Date: Apr. 28, 2005

(54) High throughput isolation of biological compounds

(76) Inventors: Henrik Frisner, Copenhagen S (DK); Lars Lehmann Hylling Christensen, Alleroed (DK)

Correspondence Address: NOVOZYMES NORTH AMERICA, INC., 500 FIFTH AVENUE, SUITE 1600, NEW YORK, NY, 10110, US

(21) Appl. No.: 10/493,842

(22) PCT Filed: Oct. 29, 2002
(86) PCT No.: PCT/DK02/00717

(30) Foreign Application Priority Data
Oct. 30, 2001 (DK) PA 2001 01598

(51) Int. Cl. F26B 19/00

(52) U.S. Cl. 34/60

(57) ABSTRACT

A method for high throughput micro-purification of a library of tag-free biological compounds is claimed wherein a population of discrete liquid samples comprising the library of tag-free biological compounds is contacted with a solid chromatographic material comprising a functional group selected from ion exchange materials, hydrophobic materials, affinity materials and hydrophobic charge induction materials so as to retain the tag-free biological compounds of the library, isolating the chromatographic material retaining the biological compounds, releasing the biological compounds of the library from the solid chromatographic material and collecting the released biological compounds of the library to produce a population of samples comprising the isolated biological compound.

### FIELD OF THE INVENTION

The present invention relates to a method for isolating tag-free biological compounds of a library present in a population of small volume samples. Further the invention relates to a method of screening a library of biological compounds for compound having improved properties. Still further, the invention relates to kits for performing the isolation or the screening method.

### BACKGROUND OF THE INVENTION

Methods for purification of biological samples are known e.g. from EP 1069131, titled “Methods for separating particulate substrates from solution while minimizing particle loss”.

Another method is described in U.S. Pat. No. 5,886,155, titled “Purification of miraculin glycoprotein using tandem hydrophobic interaction chromatography”. A still further method is described in U.S. Pat. No. 4,895,806, titled “Device for liquid chromatography or immobilized enzyme reaction”.

Boschetti E. et al., Hydrophobic charge-induction Chromatography, Genetic Engineering, Vol. 20, No. 13, 2000 describes use of a hydrophobic charge-induction material, mercaptoethylpyridine (MEP), as a material for capturing biological macromolecules such as antibodies and enzymes.

Screening procedures, in particular high throughput procedures, applied by biotech industry often involve testing of thousands or even millions of small volume test fermentations for new and/or improved biological compounds expressed by cells and/or microorganisms. Separation and/or isolation of the biological compound of interest may frequently offer an advantage in determining if the expressed biological compound is indeed novel or does indeed offer any improvements such as improved yields, improved activity, improved stability etc. Assessment of such properties of a biological compound of interest will often be impeded if various interfering components from the fermentation culture broth are present in a sample. Such interfering components often generate false positive results. By purifying a biological compound, such as a protein of interest, it will be easier to determine the concentration of the protein of interest, thus making it possible to test performance of the protein of interest even if it is strongly affected by protein concentration.

However, purifying such test fermentation samples represents an overwhelming task considering the huge number of samples as well as the small sample volumes. Hence, there exists a need for methods capable of purifying small volume samples where it is preferable to avoid tagged molecules and to obtain samples that can easily be compared in high throughput format.

One object of the invention is to provide a purification method which enables fast (high throughput) purification or isolation of tag free biological compounds present in small volume sample, so that libraries of biological compounds may be purified.

A further object of the invention is to provide a method that is flexible with respect to physico-chemical properties of the biological compound.

A still further object of the invention is to provide a method, which is independent of incorporating a tagging sequence, such as a series contiguous histidine units or glutathione s-transferase into the biological compound with the purpose of creating an attachment site capable of binding the biological compound to a support material.

### SUMMARY OF THE INVENTION

As a solution to the objectives described, vide supra, the present invention provides in a first aspect a method of isolating tag-free biological compounds of a library comprising the steps of
(1) preparing a library of tag-free biological compounds,
(2) contacting, in solution, a population of discrete liquid samples comprising the library of tag-free biological compounds, each sample having a volume of less than 3.7 ml with a solid chromatographic material comprising a functional group selected from ion exchange materials, hydrophobic materials, affinity materials and hydrophobic charge induction materials so as to retain the tag-free biological compounds of the library on the material,
(3) isolating the chromatographic material retaining the biological compounds of the library from the samples,
(4) releasing the biological compounds of the library from the solid chromatographic material and
(5) collecting the released biological compounds of the library to produce a population of samples comprising the isolated biological compound.

In a further aspect the invention provides a method of screening a library of tag-free biological compounds for biological compounds with improved properties comprising the steps of isolating the biological compounds of the library using the above mentioned isolation method, testing at least one property of the isolated biological compounds of the library and selecting biological compounds having at least one improved property.

In a still further aspect the invention provides a kit for isolating tag-free biological compounds of a library comprising a population of at least 24 containers, having a volume of 3.7 ml or less, capable of holding a population of discrete liquid samples comprising a library of tag-free biological compounds, means for mixing the liquid samples with a solid chromatographic material comprising a functional group selected from ion exchange materials, hydrophobic materials, affinity materials and hydrophobic charge induction materials so as to retain the tag-free biological compounds of the library on the material, means for separating the tag-free biological compounds of the library retained on said material from the liquid sample and optionally means for releasing the tag-free biological compounds of the library from said material.

In a still further aspect the invention provides a kit for screening a library of tag-free biological compounds for tag-free biological compounds having at least one improved property comprising the kit for isolation of tag-free biological compounds of a library, as described, supra, means for testing at least one property of the tag-free biological compounds of the library and means for selecting tag-free biological compounds having an improved property.

### BRIEF DESCRIPTION OF THE DRAWINGS

FIG. 1 shows the fluorescence of pooled eluates from micro purification of 96 protease variants as a function of protease concentration in pooled eluates determined by active site titration (AST).

### DETAILED DESCRIPTION OF THE INVENTION

Definitions

The term “retain” in the context of retaining the biological compound to a chromatographic material is to be understood as the biological compound being bound to the chromatographic material by covalent, ionic, hydrogen and/or hydrophobic bonding.

The term “chromatographic material” is to be understood as a material comprising functional groups coupled to a support material. The functional groups are in particular coupled to the support material by covalent bonds. The covalent bonds are in particular stable at moderately alkaline to moderately acidic pH conditions, such as pH 2-12. The support material is in particular a polymer, in particular those having a poor solubility in water. One example of a chromatographic material is cellulose mercaptoethylpyridine (MEP), e.g. known as MEP HyperCel®. Here the support material is a cellulose polymer and the functional groups are mercaptoethylpyridine units covalently bound to the cellulose.

The term “hydrophobic charge induction material” is to be understood as a functional group which is a hydrophobic material capable of forming hydrophobic bonds to a hydrophobic molecule or a hydrophobic part of a molecule when a surrounding aqueous medium has a pH within a sub-range of a suitable pH range. If the pH of the surrounding aqueous medium is outside the sub-range but within the suitable pH range the functional group is charged with either a negative or positive charge. A suitable pH range is a range of pH values at which a biological compound in an aqueous medium is functionally and/or structurally stable for at least the time required to retain and release the biological compound from the hydrophobic charge induction material in a method for isolating said biological compound. For some biological compounds, e.g. enzymes, the suitable pH range may be quite broad such as pH 2-7 or 7-12. Certain alkaline enzymes suitable for incorporation in detergents have optimum functionality in an alkaline medium. For example the protease Savinase® has an optimum functionality within pH 8.5-11, but will remain functional for some time in a range of e.g. pH 4.5-12, particularly such as pH 7-12. Similar observations may be made for certain acidic enzymes. For some biological compounds the suitable pH range is much narrower. Nevertheless, one object of the invention is to identify hydrophobic charge induction materials suitable for isolation of various classes of biological compounds.

The term “ion exchange material” is to be understood as a functional group which is charged when a surrounding aqueous medium is within a suitable pH range. Within this pH range the ion exchange material is capable of forming electrostatic bonds to an oppositely charged molecule or part of a molecule. The ion exchange material is further characterized in that a biological compound electrostatically bound to a ion exchange material may be competitively replaced by other oppositely charged molecules such as excess salt ions.

The term “hydrophobic material” is to be understood as a functional group which is a hydrophobic moiety.

The term “affinity material” is to be understood as a functional group which is a complex structure having multiple properties. The functional group may e.g. comprise a combination of one or more moieties selected from hydrophobic, hydrophilic, positively charged and negatively charged moieties positioned in a specific and well defined 3 dimensional structure suitable to bind only certain types or even specific biological compounds.

The term “library” as used herein is to be understood as a collection of different or diversified biological compounds, in particular present in separate discrete samples. A library usually consist of at least 10 different biological compounds, particularly at least 50, more particularly at least 100, even more particularly at least 500, more particularly at least 1000 biological compounds. In a particular embodiment the library originates from fermenting a population of host cells, transformed or transfected with nucleotide sequences encoding variants of a polypeptide. In that case the library of biological compounds is a collection of polypeptide variants obtained by mutating or diversifying a nucleotide sequence encoding a parent polypeptide and expressing mutated nucleotide sequences in host cells to produce the library of polypeptide variants.

The term “population” as used herein is to be understood as a collection of similar entities. For example a population of host cells is a collection of cells of the same strain, while a population of samples or containers is a collection of samples or containers having the same volume. A population usually comprise more than 10 units of the entity, in particular more than 20 units, more particular more than 30 units, more particular more than 50, more particular more than 95, more particular more than 300, more particular more than 383, more particular more than 500, more particular more than 1000, more particular more than 1500 units of the entity.

The term “tag-free” as used herein in the context of tag-free biological compounds is to be understood as biological compounds, which are free of any artificial groups or domains artificially inserted in the biological compound and capable of attaching to a predetermined group on a support material designed especially to form bonds with the artificial groups in the tagged biological compound. One example of such an artificial tag group is a group of 2 or more consecutive histidine residues in a protein, polypeptide or peptide or in particular the so called 6xhis tag e.g. known from EP 1069131, which will bind to divalent metal ions. Another example of an artificial tag group is glutathion s-transferase which when fused to a polypeptide will enable binding of the polypeptide to glutathion functional groups. The term “biological compound”, which is used extensively in the present application, is to be understood as a tag-free biological compound unless specifically stated otherwise.

The term “isolating” as used herein is to be understood as treating a first solution comprising a biological compound in a manner to yield a second solution comprising the biological compound, wherein either the concentration of biological compound of the second solution is higher than that of the first solution and/or the ratio of biological compound to other dissolved or suspended matter in the second solution is higher than that of the first solution. In the context of the present invention the term “purified” with the intent of having the same meaning as term “isolated”.

Discrete Liquid Samples

A common problem when purifying e.g. proteins obtained from fermentation cultures is the need for mechanical separation of cells or cell debris by e.g. centrifugation or filtration in order to avoid clogging problems when loading samples on columns. The present invention makes possible the rapid purification of multiple samples at the same time without any need for an initial separation or purification step before bringing the sample in contact with the solid chromatographic material. The discrete liquid samples can according to the invention be provided as crude cell culture samples, especially when bacterial cultures are used for providing the biological compounds. Such bacterial cultures could e.g. comprise bacteria which secrete the desired tag-free biological compound to the culture medium. In case the bacteria do not secrete the biological compound, lysis of the bacterial cells will be necessary before contacting the culture samples with the solid chromatographic material, however, still no separation step prior to loading will be needed.

The Tag-Free Biological Compound

The biological compound to be purified or isolated may be any tag-free biological compound of interest.

In one embodiment the biological compound is a protein, a polypeptide or a peptide, particularly an enzyme or a pharmaceutical such as a hormone.

In another embodiment the biological compound is a carbohydrate, such as hylauronic acid or a lipid.

The biological compound may also be a combination of peptides, carbohydrates and lipids, such as glycopeptides, lipopeptides or glycolipids.

In a particular embodiment the biological compound may be chargeable, i.e. comprise one or more groups which at suitable conditions may become charged. Such biological compounds have in particular a μl between 1-14, more particularly between 2-12 or 4-10. Further, the biological compound of interest may in particular have a molecular weight of 500-500,000 g/mole.

In the embodiment of the invention, where the biological compound is a protein or polypeptide, particularly enzymes or enzyme variants are of interest. It is to be understood that enzyme variants (produced, for example, by recombinant techniques) are included within the meaning of the term “enzyme”. Examples of such enzyme variants are disclosed, e.g., in EP 251,446 (Genencor), WO 91/00345 (Novo Nordisk), EP 525,610 (Solvay) and WO 94/02618 (Gist-Brocades NV).

The enzyme classification employed in the present specification with claims is in accordance with Recommendations (1992) of the Nomenclature Committee of the International Union of Biochemistry and Molecular Biology, Academic Press, Inc., 1992.

Accordingly the types of enzymes which may appropriately be purified according to the invention include oxidoreductases (EC 1.-.-.-) transferases (EC 2.-.-.-), hydrolases (EC 3.-.-.-), lyases (EC 4.-.-.-), isomerases (EC 5.-.-.-) and ligases (EC 6.-.-.-).

In particular oxidoreductases in the context of the invention are peroxidases (EC 1.11.1), laccases (EC 1.10.3.2) and glucose oxidases (EC 1.1.3.4)].

In particular transferases are transferases in any of the following sub-classes:
a) Transferases transferring one-carbon groups (EC 2.1);
b) transferases transferring aldehyde or ketone residues (EC 2.2); acyltransferases (EC 2.3);
c) glycosyltransferases (EC 2.4);
d) transferases transferring alkyl or aryl groups, other that methyl groups (EC 2.5); and
e) transferases transferring nitrogeneous groups (EC 2.6).

A particular type of transferase in the context of the invention is a transglutaminase (protein-glutamine γ-glutamyltransferase; EC 2.3.2.13). Further examples of suitable transglutaminases are described in WO 96/06931 (Novo Nordisk A/S).

In particular hydrolases in the context of the invention are: Carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as α-amylases (EC 3.2.1.1); peptidases (EC 3.4, also known as proteases); and other carbonyl hydrolases.

In the present context, the term “carbohydrase” is used to denote not only enzymes capable of breaking down carbohydrate chains (e.g. starches or cellulose) of especially five- and six-membered ring structures (i.e. glycosidases, EC 3.2), but also enzymes capable of isomerizing carbohydrates, e.g. six-membered ring structures such as D-glucose to five-membered ring structures such as D-fructose. Carbohydrases of relevance include the following (EC numbers in parentheses): α-amylases (EC 3.2.1.1), -amylases (EC 3.2.1.2), glucan 1,4-α-glucosidases (EC 3.2.1.3), endo-1,4-beta-glucanase (cellulases, EC 3.2.1.4), endo-1,3(4)-β-glucanases (EC 3.2.1.6), endo-1,4-β-xylanases (EC 3.2.1.8), dextranases (EC 3.2.1.11), chitinases (EC 3.2.1.14), polygalacturonases (EC 3.2.1.15), lysozymes (EC 3.2.1.17), β-glucosidases (EC 3.2.1.21), α-galactosidases (EC 3.2.1.22), β-galactosidases (EC 3.2.1.23), amylo-1,6-glucosidases (EC 3.2.1.33), xylan 1,4-β-xylosidases (EC 3.2.1.37), glucan endo-1,3-β-D-glucosidases (EC 3.2.1.39), α-dextrin endo-1,6-α-glucosidases (EC3.2.1.41), sucrose α-glucosidases (EC 3.2.1.48), glucan endo-1,3-α-glucosidases (EC 3.2.1.59), glucan 1,4-β-glucosidases (EC 3.2.1.74), glucan endo-1,6-β-glucosidases (EC 3.2.1.75), arabinan endo-1,5-α-L-arabinosidases (EC 3.2.1.99), lactases (EC 3.2.1.108), chitosanases (EC 3.2.1.132) and xylose isomerases (EC 5.3.1.5).

In particular isomerases in the context of the invention are glycoseisomerases.

In particular lyases in the context of the invention are polysaccharide lyases.

In another embodiment the biological compound is an antimicrobial peptide (AMP). The peptide may be a peptide compound interacting/binding/sequestering essential cellular targets. The peptide of interest may be an antimicrobial enzyme or a short peptide (less than 100 amino acid residues), e.g., an antimicrobial peptide or an anti-tumor peptide.

The antimicrobial enzyme may be, e.g., a muramidase, a lysozyme, a protease, a lipase, a phospholipase, a chitinase, a glucanase, a cellulase, a peroxidase, or a laccase. Alternatively, the biological compound may be an enzyme synthesizing conventional antibiotics, e.g. polyketides or penicillins.

The antimicrobial peptide (AMP) may be, e.g., a membrane-active antimicrobial peptide, or an antimicrobial peptide affecting/interacting with intracellular targets, e.g. binding to cell DNA. The AMP is generally a relatively short peptide, consisting of less than 100 amino acid residues, typically 20-80 residues. The antimicrobial peptide has bactericidal and/or fungicidal effect, and it may also have antiviral or antitumour effects. It generally has low cytotoxicity against normal mammalian cells.

The antimicrobial peptide generally has a highly cationic portion and a hydrophobic portion. It typically contains several arginine and lysine residues, and it may not contain a single glutamate or aspartate. It usually contains a large proportion of hydrophobic residues. The peptide generally has an amphiphilic structure, with one surface being highly positive and the other hydrophobic.

The bioactive peptide and the encoding nucleotide sequence may be derived from plants, invertebrates, insects, amphibians and mammals, or from microorganisms such as bacteria and fungi.

The antimicrobial peptide may act on cell membranes of target microorganisms, e.g. through nonspecific binding to the membrane, usually in a membrane-parallel orientation, interacting only with one face of the bilayer.

The antimicrobial peptide typically has a structure belonging to one of five major classes: α helical, cystine-rich (defensin-like), β-sheet, peptides with an unusual composition of regular amino acids, and peptides containing uncommon modified amino acids.

Examples of alpha-helical peptides are Magainin 1 and 2; Cecropin A, B and P1; CAP18; Andropin; Clavanin A or AK; Styelin D and C; and Buforin II. Examples of cystine-rich peptides are α-Defensin HNP-1 (human neutrophil peptide) HNP-2 and HNP-3; β-Defensin-12, Drosomycin, γ1-purothionin, and Insect defensin A. Examples of β-sheet peptides are Lactoferricin B, Tachyplesin I, and Protegrin PG1-5. Examples of peptides with an unusual composition are Indolicidin; PR-39; Bactenicin Bac5 and Bac7; and Histatin 5. Examples of peptides with unusual amino acids are Nisin, Gramicidin A, and Alamethicin.

Another example is the antifungal peptide (AFP) from Aspergillus giganteus.

Most particular, the biological compound is selected from proteases (subtilisins), pectate lyases, alfa-amylases and amyloglycosidases.

Solid Chromatographic Materials for Retaining the Tag-Free Biological Compound

The solid chromatographic materials used for retaining the tag-free biological compound comprise a functional group which is selected from ion-exchange materials, hydrophobic materials, affinity materials and hydrophobic charge induction materials or mixtures thereof. In order to facilitate the separation of retained biological compounds from the sample, the solid chromatographic material may be coupled to another solid entity, such as a ball or a bead. In particular such solid entity may be of a magnetic nature such that the solid chromatographic material may be controlled by a magnetic field. Several suitable solid chromatographic materials are described in “Concepts in Protein Engineering and Design”, Wrede P & Schneider G, eds. Walter de Gruyter & Co., D-10785 Berlin, 1994.

Chromatographic Materials Comprising Ion-Exchange Materials

In chromatographic materials comprising ion exchange materials the support material may be hydrophilic synthetic or naturally occurring polymers such as cellulose, dextran, agarose or silica gels. The support material may also be hydrophobic polystyrene-based or partly hydrophobic polymethacrylate-based polymers or various synthetic hydrophilic polymers supplied as hard or moderately hard beads. If the ion exchange material is an anion exchange material the functional group may be diethyl aminoethyl (DEAE), triethyl aminoethyl (TEAE), trimethyl hydroxypropyl (QA), quaternary aminomethyl (O), among others. Hydroxyapatite may also be employed as an anion exchanger. For cation exchangers carboxymethyl (CM), orthophosphate (P), or sulfonate (S) may be employed as functional group.

Chromatographic Materials Comprising Hydrophobic Materials

In chromatographic materials comprising hydrophobic materials agarose may be used as support material, while the functional groups may be alkyl chains, in particular octyl or phenyl groups.

Chromatographic Materials Comprising Affinity Materials

In Chromatographic materials comprising affinity materials the support material may in particular be agarose, cellulose, or silica. Functional groups can be any compound capable of participating in biological or bio-mimetic interactions between ligand and counter ligand. Suitable functional groups include but is not limited to antibodies (monoclonal, polyclonal, recombinant capable of complex interaction with antigens), antigens (capable of complex interaction with antibodies), lectin (capable of complex interaction with carbohydrate moieties of e.g. glycoproteins), inhibitors (capable of complex interaction with enzyme), enzymes (capable of complex interaction with inhibitors), receptors (capable of complex interaction with messenger molecules), messenger molecules (capable of complex interaction with receptors).

A particular type of suitable inhibitors are substrate analogues and/or competitive inhibitors. These may in particular be molecules comprising a mixture of L and D amino acids.

Chromatographic Materials Comprising Hydrophobic Charge Induction Material

In Chromatographic materials comprising hydrophobic charge induction material, the functional group of hydrophobic charge induction materials offers a number of advantages. One advantage is that the retention of the biological compound is based on mild hydrophobic interaction, which may be achieved under near physiological conditions, without the addition of lyotropics or other salts. Another advantage is that the release of the biological compound may be achieved using gentle dilute buffers which do not harm the biological compound. A further advantage is that samples may be prepared without adjustment of ionic strength and for some hydrophobic charge induction materials without adjustment of pH. A still further advantage is that the capacity for retaining biological compounds of functional groups of hydrophobic charge induction materials is often so high, that a pre-concentration of samples is not required. A still further advantage is that many hydrophobic charge induction materials are stable in highly alkaline solutions meaning that the material may be cleaned using a solution of sodium hydroxide. A still further advantage is that low ionic strength aqueous buffers, which do not affect subsequent assaying for desired properties, can be used to liberate the biological compound of interest from the chromatographic material.

In one embodiment the functional group is uncharged at acidic pH, such as below 7, particularly below 6, more particularly below 5, even more particularly below 4, even more particularly below 3. Particular functional groups are in addition to or as an alternative to this embodiment charged at alkaline pH, such as above 7, particularly above 8, more particularly above 9, even more particularly above 10, even more particularly above 11. We have found that this will allow retaining and release of low pi protein at suitable conditions. One such functional group having this property is ortho-nitrophenol, which is charged at pH above a pKa of 7.2 and uncharged at pH below this pKa. Another such functional group is mercaptoethylpyridine (MEP), which is charged at acidic pH below the pKa of 4.8 and uncharged at neutral to alkaline pH.

One advantage of using a hydrophobic charge induction material is that it is not required to tag the biological compound with an artificial moiety specifically designed to enable retention of the biological compound. Such tag's are known e.g. as consecutive charged histidine residues (His-tagging of proteins) or as fusion of glutathion s-transferase to a protein, supra. This advantage is of importance because, tagging, such as His tagging may affect performance or structure of the protein or the His-tag may be unstable (this is often the case with proteases).

One advantage of using a hydrophobic charge induction material in comparison with ion-exchange materials is that use of ion-exchange materials requires reduction of ionic strength in samples, such as crude culture broth samples, e.g. by dilution or removal of salt (e.g. by dialysis) before purification, because the salt may occupy the binding sites of the ion-exchange material. This is not necessary when using hydrophobic charge induction materials, because the binding of the biological compound is hydrophobic. Furthermore, release or elution from hydrophobic charge induction materials can be accomplished by simple pH change with buffer of low ionic strength possible, i.e. no requirement for salt etc. in elution buffer. This can be important for subsequent screening of the biological compound, such as testing the biological compound in application relevant assays (e.g. a washing assay), where presence of salt or strong buffers can affect performance.

Isolating Tag-Free Biological Compounds

Preparing a Library of Biological Compounds

The library of biological compounds may be prepared by any conventional method, such as genetic engineering. The preparation of a library of polypeptides may for instance be achieved by:
(1) preparing a library of nucleic acid sequences (a gene library) encoding polypeptides, (2) inserting the gene library into a population of host cells and (3) expressing the gene library in the host cells so as to produce a library of polypeptides.

Preparation of a gene library can be achieved by use of known methods.

Procedures for extracting DNA from a cellular nucleotide source and preparing a gene library are described in e.g. Pitcher et al., “Rapid extraction of bacterial genomic DNA with guanidium thiocyanate”, Lett. Appl. Microbiol., 8, pp 151-156, 1989; Dretzen, G. et al, “A reliable method for the recovery of DNA fragments from agarose and acryla-mide gels”, Anal. Biochem., 112, pp 295-298, 1981, WO 94/19454 and/or, Diderichsen et al., “Cloning of aldB, which encodes alpha-acetolactate decarboxylase, an exoenzyme from Bacillus brevis”, J. Bacteriol., 172, pp 4315-4321,1990.

Procedures for preparing a gene library from an in vitro made synthetic nucleotide source can be found in e.g. Stemmer, Proc. Natl. Acad. Sci. USA, 91, pp. 10747-10751, 1994, Stemmer, Nature, 370, pp. 389-391, 1994 or WO 95/17413.

The nucleotide sequences of the gene library may have been subjected to classical mutagenesis, e.g. by UV irradiation of the cells or treatment of cells with chemical mutagens as described by Gerhardt P. et al.; Methods for general and molecular biology; American Society for Microbiology; 1994; Eds: Gerhardt P., Murray R. G. E., Wood W. A., Krieg N. R.

In addition to or alternatively the nucleotide sequences of the gene library may have been genetically modified by in vivo gene shuffling as described in WO 97/07205.

In addition to or alternatively the nucleotide sequences of the gene library may be in vitro made preparations of sequences of DNA, RNA, cDNA or artificial genes obtainable by e.g. gene shuffling (e.g. described by Stemmer, (1994), supra, or WO 95/17413), random mutagenesis (e.g. described by Eisenstadt et al., Gene mutation, Methods for general and molecular bacteriology, pp. 297-316, Eds: Gerhardt P., Murray R. G. E., Wood W. A. and Krieg N. R., ASM, 1994) or constructed by use of PCR techniques (e.g. described by Poulsen et al., Topographic analysis of the toxic Gef protein from Escherichia coli, Molecular Microbiology, 5(7), pp. 1627-1637, 1991).

Procedures for transformation of a host cell by insertion of a plasmid comprising a DNA or cDNA fragment from a gene library is well known to the art, e.g. Sambrook et al., “Molecular cloning: A laboratory manual”, Cold Spring Harbor lab, Cold Spring Harbor, N.Y. (1989), Ausubel et al. (eds.), Current protocols in Molecular Biology, John Wiley and Sons, 1995 and Harwood and Cutting (eds.), “Molecular Biological Methods for Bacillus”, John Wiley and Sons, 1990.

The plasmid to be inserted into a host cell may contain a nucleotide sequence (denoted as an antibiotic marker), which may enable resistance of a transformant to an antibacterial or antifungal agent e.g. an antibiotic. Resistance to chloramphenicol, tetracycline, kanamycin, ampicillin, erythromycin or zeocin is preferred.

In one embodiment the pSJ1678 plasmid DNA of WO 94/19454 and Diderichsen et al., J. Bacteriol., 172, pp 4315-4321,1990., which enables resistance to chloramphenicol, may be used for transforming a SJ2 E. coli host cell. Alternatively the plasmid pZErO-2 (Invitrogen, CA, USA) may be used).

The host cell according to the definition may be any cell able of hosting and expressing a nucleotide fragment from a gene library.

The host cell may not in itself contain or express nucleotide sequences encoding for biological compounds of interest (i.e. untransformed host cells are unable of significantly expressing the biological compound). This cell characteristic may either be a natural feature of the cell or it may be obtained by deletion of such sequences as described e.g. in Christiansen et al., Xanthine metabolism in Bacillus subtilis: Characterization of the xpt-pbuX operon and evidence for purine and nitrogen controlled expression of genes involved in xanthine salvage and catabolism, Journal of Bacteriology, 179(8), pp 2540-2550, 1997 or Stoss et al., Integrative vector for constructing single copy translational fusions between regulatory regions of Bacillus subtilis and the bgaB reporter gene encoding a heat stable beta-galactosidase, FEMS Microbiology Letters, 150(1), pp 49-54, 1997.

In one embodiment the host cell is a bacterial cell or an eucaryotic cell. Further the bacterial cell is preferably a ElectroMAX DH10B (GibcoBRL/Life technologies, UK) cell or of the genus E. coli, e.g. SJ2 E. coli of Diderichsen et al. (1990) (supra). Other preferred host cells may be strains of Bacillus, such as Bacillus subtilis or Bacillus sp. A preferred eucaryotic cell is yeast, e.g. S. cerevisae.

The library of biological compounds is in a particular embodiment in the form of library of fermentation broths comprising biological compounds and the culture of host cells expressing the biological compounds. The method of the invention may in a particular embodiment include subjecting the library of fermentation broths to size exclusion chromatography before retaining the biological compounds on the chromatographic material. Size exclusion chromatography material may be applied to remove small components like salts from the culture broth. Low molecular weight components may interfere with subsequent screening of the isolated biological compounds.

The library of biological compounds to be retained, e.g. in the form of fermentation broths, is in a particular embodiment in the form of small volume discrete samples of less than 3.7 ml. However, when preparing a library of biological samples, e.g. by fermenting a population of host cells comprising a library of nucleotide sequences encoding the library of biological compounds, the sample volumes may be smaller, such as volumes sufficiently small to be contained in wells of modern micro plates. The method of the invention works even when using very small sample volumes, which can be applied to increase the sample capacity. Accordingly the sample volume may be comparable to the well volume of commercially available micro plates. A suitable volume is less than the well volume of a 24 well micro plate, preferably less than the volume of a well on a 96, 384 or 1536 well plate. Based on the type of micro plate, the volume can be chosen e.g. as 5-95% of the volume of the well, which is 3.7 ml, 320 μl, 160 μl, and 14 μl, respectively. When using such small volumes it is possible to purify a substantially larger number of samples per hour, than with conventional methods. Hence the method of the invention may be classified as the first High Throughput Purification method for tag-free biological compounds.

Retention of the Biological Compound on the Solid Chromatographic Material

Retention of the biological compound may be achieved by contacting, in solution, the biological compound with the solid chromatographic material.

The chromatographic material may be in any suitable form, in particular a form, wherein a maximum of the chromatographic material is exposed to the biological compound. The chromatographic material may also be combined with a magnetic material so that the chromatographic material may be physically controlled by applying a magnetic field.

In one embodiment the chromatographic material, particularly in the form of a solid ball or a bead or other solid structures comprising the chromatographic material, is simply added to a sample comprising the biological compound at condition wherein the biological compound will bind the chromatographic material.

In one embodiment contacting the discrete samples comprising the library of tag-free biological compounds with the solid chromatographic material may be performed in a population of wells in a micro-titer plate, in particular those fitted with a filter, particularly at the bottom of the wells.

In another embodiment the vessels are a population of hollow vessels, such as small volume chromatography columns, in which the chromatographic material is packed. These hollow vessels allow samples comprising biological compounds to pass the chromatographic material whereby the biological compounds are retained in the columns.

To ensure that only biological compounds with substantial affinity towards the solid chromatographic material are retained, the amount of solid chromatographic material may be limited so that the chromatographic material is substantially saturated with biological compounds of interest leaving little or no space available for retaining other constituents of the samples. In particular one should use less than 10.000 mg chromatographic material per mg biological compound of interest in a sample, in particular less than 5000 mg, more particularly less than 1000 mg chromatographic material per mg biological compound of interest in a sample. One advantage of using a limited amount of chromatographic material is that a constant amount of biological compound may be retained, so that a need for subsequent quantification (which is useful when using the isolated biological compound in tests for improved properties) may be eliminated. By applying a limiting amount of chromatographic material, only a fraction of the biological compound in a sample will be bound, thus differences in levels of biological compound in different samples will not affect the amount of isolated biological compound. Such an approach will make automation simpler as it eliminates the necessity for using variable sample volumes for each sample of isolated biological compound when testing for improved properties.

Isolating the Chromatographic Material Retaining the Biological Compounds of the Library from the Samples.

When the biological compounds have been retained on the chromatographic material the chromatographic material is isolated from the unbound constituents of the samples.

When a vessel or container with a filter is used the chromatographic material retaining the biological compounds may be isolated by filtering the sample through the filter leaving the chromatographic material on the filter.

When the vessel is a hollow vessel, such as a column wherein the chromatographic material is packed, the isolation of the chromatographic material retaining the biological compounds may be achieved by flushing the samples through the hollow vessel allowing impurities to flow past the chromatographic material.

In a particular embodiment micro-titer plates (e.g. Whatman, Unifilter 800 μl, 25-30 μm MBPP) equipped with filters in the bottom of the wells are used.

Removal of liquid from filter-bottomed micro-titer plates is a central step in the practical examples provided. In particular the method of the invention can be carried out by placing the filter plates on top of a standard micro-titer vacuum unit (such as a Whatman Univac 3), which provides controlled sub-atmospheric pressure underneath the filters, while the top side of the micro-titer plate is open to the ambient atmospheric pressure. In practise, it has been found that it can be difficult to obtain complete and uniform drain of all wells of a micro-titer plate once some of the wells have been drained and others not. To solve this problem we have developed a special lid, which divides the space above the filter plate into individual compartments isolated from ambient pressure. The number of compartments on the lid should correspond to the number of wells in the micro-titer plate. The compartments can e.g. be provided by a suitable grid of a rubber material or similar material. The basic shape of the lid is the same as a micro-titer plate turned upside down. A coating with rubber or similar material ensures sufficient contact between the bottom of the lid and the filter plate so that each individual compartment is air tight. This construction ensures that a vacuum is maintained in each filter-bottomed well until the liquid from the well is drained through the filter. Draining of one well has no influence on the other wells. Regarding the physical form of the lids, we have obtained successful results with 1 cm³ head space in each lid compartment. Obviously, increasing this volume only benefits the technique. We expect that the compartment size could be as low as 0.1 cm³ head space depending on the particular resistance towards liquid drain.

Washing the Retained Biological Compound

When the biological compound has been retained on the solid chromatographic material it may optionally be further freed of impurities by washing the chromatographic material in one or ore washing steps.

When the chromatographic material comprises hydrophobic charge induction materials the washing is performed by contacting chromatographic material with a washing liquid. The ashing is in particular carried out at conditions which prevent substantial release of the biological compound to the liquid, e.g. less than 5%. In particular the washing liquid is a buffer solution having a pH enabling continued binding of the biological compound to the chromatographic material. If more than one washing step is performed the buffer may for each washing cycle be increasingly diluted. The buffer may be the same buffer as used for preparing the sample before retaining the biological compound on the chromatographic material.

When the chromatographic material comprises ion exchange materials, the washing solution has an ionic strength sufficiently low to prevent substantial release of the biological compound, e.g. less than 5%. If more than one washing step is performed the ionic strength of washing solution in each washing cycle may be increased or decreased.

When the chromatographic material comprises hydrophobic materials, the washing solution has a polarity and/or hydrophilicity sufficiently high to prevent substantial release of the biological compound, e.g. less than 5%. If more than one washing step is performed the polarity and/or hydrophilicity washing solution may for each washing cycle be increasing or decreased.

When the chromatographic material comprises affinity materials, formulating a suitable washing solution may depend on the mode of binding of the biological compound to the affinity material. Hence, the washing solution should be formulated to prevent substantial release of the biological compound, e.g. less than 5%. The formulation may include careful control of pH ionic strength and polarity of the washing liquid.

The continuous phase of the washing liquid may be aqueous or organic. However it is important that the biological compound preserves its functional properties while in contact with the washing liquid.

In the case, supra, the vessel holding the biological compound retained on the chromatographic material is a well in a micro plate fitted with a filter in the bottom of the well, the washing liquid in each washing cycle may be removed through the filter leaving the purified biological compound retained on the chromatographic material on the filter.

In the case, supra, the chromatographic material is packed in a hollow vessel, such as a column, the washing liquid in each washing cycle may simply be flushed through the hollow vessel allowing impurities to flow with the washing liquid, while retaining biological compound retained on the chromatographic material.

Releasing the Biological Compound from the Solid Chromatographic Material

The retained biological compound may be released from the chromatographic material by a suitable change in the medium surrounding the retained biological compounds.

This change may be a change in the pH (for hydrophobic charge induction materials), a change in ionic strength or types of salt present in the medium (ionic exchange materials), a change in the polarity of medium (hydrophobic materials) and/or a change in temperature and or any combination of said changes (affinity materials). In a particular embodiment the release mechanism is changing the pH. In particular hydrophobic charge induction materials is used so that the biological compounds may be released by raising the pH, in particular to an alkaline pH, whereby the hydrophobic charge induction material becomes charged. In another embodiment release of the biological compound is achieved by lowering the pH.

In practice release of the biological compound is effected by contacting the biological compound retained on the chromatographic material with a release liquid having suitable properties such as a preset pH, ionic strength, salt concentration, polarity, temperature or a combination thereof, whereby the biological compound is released to the release liquid. Particularly the release liquid is capable of releasing at least, 50% of the biological compound, more particularly at least 75%, more particularly at least 90%, more particularly at least 95% of the biological compound.

The continuous phase of the release liquid may be aqueous or organic or a mixture thereof. However it is important that the biological compound preserves its functional properties while in contact with the release liquid.

Collecting the Biological Compound

Once the biological compound has been released it may be separated from the chromatographic material (which then may be reused) to produce a liquid comprising the isolated biological compound.

In the case, supra, the vessel holding the biological compound retained on the chromatographic material is a well in a micro plate fitted with a filter in the bottom of the well, collection of the release liquid comprising the biological compound may be achieved by filtering the release liquid through the filter leaving the chromatographic material on the filter.

In the case, supra, the chromatographic material is packed in a hollow vessel, such as a column, the release liquid may simply be flushed through the hollow vessel allowing release of the biological compound to the release liquid and collecting the release liquid.

Test for Monitoring the Degree of Purity of the Isolated Biological Compound

When a biological compound of interest e.g. from a crude broth of a cell culture is isolated and/or purified it may be useful to establish the purity before carrying out any further test for improved properties. This may be achieved, depending on the nature of the biological compound, by any conventional method. For example it is possible to do simple quantifications, such as UV (280 nm) absorbance and protein fluorescence to measure the purity and amount of biological compound isolated. Both techniques require no substrate and consume no sample; concentration is simply determined by an almost instant read in a spectrophotometer or spectrofluorometer.

In standard protein fluorescence, one typically runs excitation of sample at 280 nm and emission around 340 nm. Fluorescence is more sensitive than UV absorbance and is less prone to giving a false signal if sample contaminated with e.g. DNA/RNA absorbance. However, mutations involving aromatic amino acids (especially Trp) can make both fluorescence and UV absorption determination inaccurate.

To establish the purity of e.g. an isolated enzyme one can also employ active site titration with strong inhibitor and/or suitable substrates.

Other methods of quantifying the amount of isolated biological compound include use of commercially available kits from Bio-Rad to quantify protein contents of a sample.

Using the Method of Isolation for Screening of a Library of Biological Compounds for Compounds with Improved Properties

The present invention also relates to a method for screening a library of tag-free biological compounds for biological compounds with improved properties wherein the above mentioned method for isolating biological compounds is applied followed by testing at least one property of the isolated biological compounds and selecting biological compounds having an improved property.

Performing Test of Improved Properties

Relevant tests which may be performed for selection of biological compounds having improved properties include but are not limited to:
1) The performance of the biological compound in a detergent, i.e. the detergency of the biological compound, such as the ability of the biological compounds ability to remove a soiling from a textile. Several such tests are known to the skilled person, e.g. as described in WO 02/42740, wherein soiled textile swatches are treated with enzymes to evaluate the performance of the enzymes.
2) The thermal stability of the biological compound.
3) The chemical stability of the biological compound in various environments.
4) The pH stability.
5) The specific activity and/or potency of the biological compound.
6) The in vivo half-life of the biological compound in animals including man.
7) The toxicity and/or immunogenicity of the biological compound towards animals including man or cell types.

In one embodiment the test for improved properties comprises testing enzymes for their ability to convert a substrate in excess in the presence of a detergent composition, such as a laundry detergent or a dish washing detergent, particularly in the presence of oxidative components, such as bleach.

In a further embodiment the test for improved properties comprises testing, over time, biological compounds activity, such as the ability of enzymes to convert a substrate in excess, at a temperature at which the biological compound is unstable.

In a further embodiment the test for improved properties comprises testing, over time, biological compounds activity, such as the ability of enzymes to convert a substrate in excess, at a pH at which the biological compound is unstable.

In a further embodiment the test for improved properties comprises testing biological compounds activity, such as the ability of enzymes to convert a substrate in excess, to determine which biological compounds have an increased the specific activity (e.g. activity per mole or weight).

In a further embodiment the test for improved properties comprise testing the immunogenicity of biological compounds, e.g. by testing for their ability to induce an immune response in an animal including humans. The induction of an immune response may be monitored by measuring formation of antibodies such as IgA, IgE, IgG, IgM or IgD in an animal treated, e.g. by injection, with the biological compound. Alternatively or in addition, the biological compounds may be tested for immunogenicity by measuring their ability create a change in an animal cell, including human, which change is associated to an immune response in said animal including human. Particularly this change is a change in the cytokine secretion of the mammalian cell.

In a further embodiment the test for improved properties comprises testing the in vivo half-life of the biological compound in the human or animal body. An increased or decreased half-life of a biological compound within e.g. pharmaceuticals is an important property when estimating the impact of a biological compound on said body.

In a further embodiment the test for improved properties comprises testing the chemical stability of the biological compound at physiological conditions such as in the human or animal body.

In a further embodiment the test for improved properties comprises testing the toxicity of the biological compound towards prokaryotic cells including bacteria or eukaryotic cells including mammalian cells, fungi and yeasts.

Kit for Isolating Tag-Free Biological Compounds of a Library

The present invention also relate to a kit for isolating tag-free biological compounds of a library. Said kit comprises
(1) a population of at least 24 containers, having a volume of 3.7 ml or less, capable of holding a population of discrete liquid samples comprising a library of tag-free biological compounds,
(2) means for mixing the liquid samples with a solid chromatographic material comprising a functional group selected from ion exchange materials, hydrophobic materials, hydrophobic charge induction materials and affinity materials so as to retain the tag-free biological compounds of the library on the chromatographic material,
(3) means for separating the tag-free biological compounds of the library retained on the chromatographic material from the liquid sample,
(4) means for releasing the tag-free biological compounds of the library from said solid chromatographic material and
(5) means for recovering the released tag-free biological compounds.

This kit may further be used for screening a library of tag-free biological compounds for biological compounds having at least one improved property by including means for testing at least one property of the biological compounds of the library and means for selecting biological compounds having an improved property.

Population of Containers

The kit of the invention comprises a population of containers. The containers may have any desirable shape or size as long as it is suitable for carrying out automated operations such as dispensing samples, mixing etc. and suitable for organising the population in an array type of set up. Thus as described, supra, the population of container may be wells of a micro-titer plate such as a standard 24, 96, 384 or 1536 well plate. Particularly 96-well plates are suitable as they offer at sufficiently high volume to enable fermentation of cell cultures and sufficiently low volume to enable a high throughput capacity. The volume of the well should in particular be within 10-3700 μl, more particularly between 150-1000 μl, more particularly between 300-1000 μl.

The containers may be fitted with filters located (e.g. at the bottom) so as to enable filtering of samples in the containers. Particularly filters having a pore size between 1-50 μm, such as 20-30 μm are useful. The pore size should assure that chromatographic material is retained on the filter, whereas undesirable culture components e.g. cells pass through.

The containers may in one embodiment also be designed so as to allow control of any magnetic material present in the containers by a magnetic field.

Means for Mixing

The kit of the invention comprises means for mixing a sample with the chromatographic material. These means include means for shaking or stirring or the means may also reside in the design of the container optionally in combination with controlled movement of samples in the container. For example if the container is a column packed with the chromatographic material and samples are contacted with the chromatographic material by flushing the sample from one end of the column to the other the mixing is obtained simply from the movement of the sample by pressure.

Means for Separating the Retained Biological Compounds

The kit of the invention comprises means for separating a biological compound retained on a chromatographic material from other constituents of a sample. These means include filters which will allow liquid and other dissolved or dispersed constituents of a sample to pass while holding back solid chromatographic material. These means also include a magnet capable of controlling a chromatographic material associated with a magnetic material. These means also include associating the chromatographic material to a solid support of a dimension suitable for mechanically moving the support both into and away from contact with a sample. One example of such mean is a stick onto which the chromatographic material is attached. The stick can be put into a sample to bind the biological sample and taken out of the sample and put into a release liquid for release of the biological compound.

Means for Releasing and Recovering the Biological Compound

The kit of the invention comprises means for releasing and recovering isolated biological compounds. These means include means for contacting biological compounds retained on a chromatographic material with a release liquid and means for collecting the release liquid. In particular these means include means for adding the release liquid to the chromatographic material in containers, providing a second population of containers and means for distributing release liquids freed of chromatographic material from each of the containers to each of the containers of the second population.

Kit for Screening a Library of Tag-Free Biological Compounds

The present invention also relate to a kit for screening a library of tag-free biological compounds for biological compounds having at least one improved property. This kit comprises the above-mentioned kit for isolating tag-free biological compounds of a library and means for testing at least one property of the biological compounds of the library and optionally means for selecting biological compounds having an improved property.

Means for Testing a Property of the Biological Compound

The kit of the invention may optionally comprise means for testing improvements of properties.

Properties that could be tested include thermo stability, specific activity of enzymes, expression yields, pH stability, binding to polyclonal or monoclonal antibodies, inhibition with specific inhibitors, stability in combination with various chemical additives e.g. detergents and various complex performance related tests. Testing of all these properties is likely to give more reliable results with isolated biological compounds (purified samples), where interferences from components other than the biological compound of interest in the culture broth have been eliminated.

Means for Selecting Improved Biological Compounds.

The kit of the invention may optionally comprise means for selecting improved biological compounds and/or means for selecting strains expressing biological compounds having improved properties. These means may facilitate isolation of promising biological compounds for further investigation and/or collecting cells expressing promising biological compounds for identifying nucleotide sequences encoding promising biological compound. These means may be any automated or semi-automated equipment, which based on the results of a property test of biological compounds, selects samples comprising biological compounds or cells encoding biological compounds, for which the result in the property test is within a desired predetermined range. Such means include auto-pipetting systems and colony pickers linked to the equipment for testing the property.

### EXAMPLES

### Example 1

Bacillus subtilis Pectate Lyase (EC 4.2.2.2) Purification on Hydrophobic Charge Induction Chromatographic material:

Preparation of a Library of Pectate Lyase:

Culture broths containing pectate lyase was prepared in the wells of a 96-well microtiter plate by growing, in the wells, recombinant Bacillus subtilis cultures expressing the pectate lyase.

Preparation of Hydrophobic Charge Induction Chromatographic Material:

40 μl swelled chromatographic material (BioSepra MEP HyperCel F) was transferred to individual wells of a microtiter plate fitted with a filter bottom, such as Whatman, Unifilter 350, which is a 96-well plate with an approximate 30 μm filter. The material was washed with binding buffer (0.5 M Tris-HCl, 2 M (NH₄)₂SO₄, pH 8.0) by adding 200 μl/well and sucking it through the plate by use of a microtiter vacuum unit (Whatman UniVac 3). The washing was repeated three times.

Retaining the Library of Pectate Lyases on the Chromatographic Material:

120 μl culture broths were mixed with 50 μl binding buffer and transferred to the filter/sorbent wells. The filter plates were shaken with enough vigour as to allow suspension of the chromatographic material in the sample solution. After 45 min shaking at room temperature the pectate lyase was retained on the chromatographic material and the liquid of the samples was separated from the chromatographic material by transferring it to wells of a clean microtiter plate, while the chromatographic material containing the retained pectate lyase remained on the filter.

Washing the Retained Pectate Lyase:

Following the retaining of the biological compound each filter was washed with 200 μl binding buffer with shaking at room temperature in three rounds: The first for 30 minutes, the second and third for 10 minutes.

Release:

Release of retained pectate lyase was done with 200 μl/well release buffer (50 mM sodium acetate, pH 4.5). The released pectate lyase was collected in the vacuum unit after 30 min shaking at room temperature. The majority of retained pectate lyase was released with this treatment. To clean the chromatographic material, two additional release rounds were conducted. First with another 200 μl/well release buffer, secondly with release buffer containing 30% glycerol. Both these release rounds were conducted with 10 min shaking.

Determination of total protein in the various fractions was done by measuring protein fluorescence. This was done by transferring 100 μl of each collected well to a black microtiter plate (sterilin 96) and recording the ex280/em340 signal in a spectrofluorometer (BMG Polarstar). A linear dose-response in protein fluorescence was observed in the range of 0-100 μg/ml pure Bacillus subtilis pectate lyase.

Specific detection of pectate lyase in the fractions was done by employing polygalacturonic acid and measuring the increase in absorbance at 235 nm caused by the formation of conjugated double bonds upon enzymatic action on the substrate.

To verify that the pectate lyase had been purified/isolated both the crude broths and the solutions of released pectate lyase was subjected to SDS-PAGE gel chromatography for comparison. For the crude broths one strong band indicating the pectate lyase and several weaker bands indicating impurities were found, while for the solutions of released pectate lyases, only one strong band indicating the pectate lyases appeared. This indicated that the method of isolation performed in the microtiter well format was indeed very effective.

### Example 2

Purification of Protein Engineered Protease Variants

Preparation of a Library of Protease Variants:

Approximately 1000 protease variants were expressed in Bacillus subtilis by subjecting a nucleotide sequence encoding a protease to conventional site directed mutagenesis and letting the Bacillus subtilis express the protease variants. For expression of the protease variants the Bacillus subtilis encoding the variants were grown in a suitable culture medium in containers of a 96 well micro plate for 3 days at 37° C.

Preparation of Hydrophobic Charge Induction Chromatographic Material:

100 μl chromatographic material (MEP HyperCel, BioSepra) suspended in 20% ethanol was transferred to the wells of 800 μl, filter plates (Whatman, Unifilter, 96 wells, 25 μm MBPP). The material was preconditioned by washing twice for 15 min under vigorous shaking with 0.1 M CHES, 0.1 M Borate, 2 mM CaCl₂, pH 9.5. Between the preconditioning washing steps and in all subsequent steps filtering of samples/liquids through the filter was achieved by using a microtiter vacuum unit (Whatman UniVac 3). All steps were done at room temperature.

Retaining the Library of Protease Variants on the Chromatographic Material:

400 μl protease containing culture broth from each of the fermentation wells and 100 μl binding buffer (0.5 M CHES, 0.2 M borate, 2 mM CaCl₂, pH 9.5) was added to individual wells of the filter plate. After 1 hour incubation with vigorous shaking to suspend the chromatographic material, cells and unbound material were removed through the filter by vacuum.

Washing the Retained Protease Variants:

The protease variants bound on the chromatographic material was washed 5 times (15 min each) with 200 μl buffer with decreasing concentrations to remove unbound material (once with 0.1 M CHES, 0.1 M borate, 2 mM CaCl₂, pH 9.5, twice with 25 mM CHES, 25 mM borate, 2 mM CaCl₂, pH 9.5, and twice with 10 mM CHES, 10 mM borate, 2 mM CaCl₂, pH 9.5).

Release of the Protease Variants:

Release of protease variants from the chromatographic material was done by adding 200 μl 50 mM sodium acetate, pH 5.2 and incubate for 30 min with vigorous shaking. The release liquids containing the released protease variants were transferred to the individual wells of a fresh microtiter plate by vacuum. The chromatographic material was reused after washing twice with 200 μl 0.1 M citrate buffer, pH 3.0. The purity of the protease variants determined by SDS-PAGE were comparable to purities obtained for pectate lyases of example 1.

After determining the concentrations of the isolated protease variants (by Active Site Titration), the isolated protease variants were tested in a high throughput assay for their cleaning performance against a stained fabric as well as in a high throughput assay for testing the resistance of the protease variants against a protease inhibitor. In the absence of interferences from other compounds of the fermentation protease variants which showed improved cleaning performance, improved resistance to inhibitor or both could unambiguously be identified.

### Example 3

Micropurification of Glucoamylase with Cyclodextrin Coupled to Agarose as Chromotographic Medium

β-Cyclodextrin was coupled to a divinylsulfone activated agarose matrix (Kem-En-Tec, Mini-Leak High). About 10 ml agarose matrix was washed twice with water and dried by vacuum. 1 g β-cyclodextrin dissolved in 10 ml 0.5 M K₂HPO₄ pH 11.5 was added to the matrix and the mixture incubated over night with gentle mixing. Ethanolamine was added to a concentration of 0.1 M. After 2 hours incubation the matrix was washed with water and 20% ethanol.

About 50 μl cyclodextrin coupled agarose matrix was added to each of four wells of a filter plate (Whatman, Unifilter 800 μl, 25-30 μm MBPP). The matrix was washed twice with 0.1 M glycine pH 10.0 and twice with 0.1 M sodium acetate pH 4.5. In each wash 200 μl washing buffer was added to the well, the plate was incubated under vigorous shaking (Heidolph, Titramax 101, 1200 rpm) for 10 min at room temperature, and the buffer was removed by vacuum (Whatman, UniVac 3).

100 μl fermentation culture supernatant containing various amounts (about 7, 14, 21 and 42 μg) of an Aspergillus niger glucoamylase with starch binding domain and 300 μl 0.1 M sodium acetate pH 4.5 was added to each well and incubated 30 min at room temperature with vigorous shaking to allow the glucoamylases to bind to the matrix. Unbound material was removed by washing three times for 10 min with 200 μl sodium acetate buffer pH 4.5 with decreasing concentration (100, 50 and 10 mM). The glucoamylase was liberated by adding 200 μl 0.1 M glycine pH 9.0 and shaking for 15 min. The eluate was transferred to a microtiter plate containing 15 μl 0.1 M sodium acetate pH 4.0 by vacuum. This elution step was repeated three times.

Activity of the glucoamylase was measured in the added culture supernatants and the micropurified eluates by mixing 50 μl, sample (diluted with 0.1 M sodium acetate, 0.01% Triton X-100, pH 4.5) with 50 μl 0.1 M sodium acetate, 0.01% Triton X-100 pH 4.5 and 100 Ξl, 4 mM para-nitrophenyl-alpha-D-glucoside diluted in 0.1 M sodium acetate pH 4.5. After 60 min incubation at 50° C. with shaking, the reaction was stopped by adding 50 μl sodium carbonate pH 9.5 and absorbance at 405 nm measured. Results showed that 30-32% of the glucoamylase activity in the added culture supernatants was found in the 1^{st} eluate, 10-18% in the 2^{nd} eluate and 6-14% in the 3^{rd} eluate.

### Example 4

Micropurification of Glucoamylases with Acarbose Coupled to Agarose as Chromatographic Medium

Acarbose was coupled to a divinylsulfone activated agarose matrix (Kem-En-Tec, Mini-Leak High). About 10 ml agarose matrix was washed twice with water and dried by vacuum. 500 mg acarbose dissolved in 10 ml 0.5 M K₂HPO₄ pH 11.5 was added to the matrix and the mixture incubated over night with gentle mixing. Ethanolamine was added to a concentration of 0.1 M. After 2 hours incubation the matrix was washed with water and 20% ethanol.

About 50 μl acarbose coupled agarose matrix was added to two wells of a filter plate (Whatman, Unifilter 800 μl, 25-30 μm MBPP). The matrix was washed twice with 0.1 M sodium acetate pH 4.5. In each wash 200 μl washing buffer was added to the well, the plate was incubated under vigorous shaking (Heidolph, Titramax 101, 1200 rpm) for 10 min at room temperature, and the buffer was removed by vacuum (Whatman, UniVac 3). 100 μl fermentation of two culture supernatants containing Aspergillus niger glucoamylase and 300 μl 0.1 M sodium acetate pH 4.5 was added to each well and incubated is 30 min at room temperature with vigorous shaking to allow the glucoamylases to bind to the matrix. Unbound material was removed by washing three times for 10 min with 200 μl sodium acetate buffer pH 4.5 with decreasing concentration (100, 50 and 10 mM). The glucoamylase was liberated by adding 200 μl, 0.1 M glycine pH 9.0 and shaking for 15 min. The eluate was transferred to a microtiter plate containing 15 μl, 1 M sodium acetate pH 4.0 by vacuum. This 20 elution step was repeated.

Activity of the glucoamylase was measured in the added culture supernatants and the micropurified eluates by mixing 50 μl sample (diluted with 0.1 M sodium acetate, 0.01% Triton X-100, pH 4.5) with 50 μl 0.1 M sodium acetate, 0.01% Triton X-100 pH 4.5 and 100 μl, 4 mM para-nitrophenyl-alpha-D-glucoside diluted in 0.1 M sodium acetate pH 4.5. After 60 min incubation at 50° C. with shaking, the reaction was stopped by adding 50 μl, sodium carbonate pH 9.5 and absorbance at 405 nm measured. Results showed that 27-37% of the glucoamylase activity in the added culture supernatants was found in the 1^{st} eluate and 10% in the 2^{nd} eluate. Purity of the eluates was at least 95% estimated from SDS-PAGE.

### Example 5

Micropurification of Protease Variants with MEP-HyperCel and Silica Coupled Bacitracin as Chromatographic Medium

Bacitracin (Lundbeck) was coupled to an epoxy activated silica matrix (Daisogel SP-200-40/60) in a 0.1 M KH₂PO₄/NaOH, pH 8.15 buffer by incubation for five days at room temperature with gentle stirring. Residual epoxy-groups were blocked by adding 1 M Tris/HCl pH 8.0 and stirring for another day.

To each well of a filter plate (Whatman, Unifilter 800 μl, 25-30 μm MBPP) about 100 μli chromatographic medium slurry (either MEP-HyperCel or silica coupled bacitracin) was added. 100 μl binding buffer (0.5 M Tris, 25 mM sodium borate, 10 mM CaCl₂, pH 9.0 for MEP-HyperCel and 100 mM H₃BO₃, 10 mM 3,3-DMG, 2 mM CaCl₂, pH 7 for Bacitracin) and 400 μl protease variant culture was transferred to the wells of the filter plate. 4 wells were micropurified for each protease variant on each chromatographic medium. To bind the protease to the chromatographic medium, the filter plate was incubated 1 hour at room temperature with vigorous shaking (Heidolph, Titramax 101, 1200 rpm) to stir up the chromatographic medium. Cells and unbound material were transferred by vacuum (Whatman, UniVac 3) to a 96 well plate (collected to measure non-bound activity).

MEP-HyperCel was washed once with 0.1 M Tris, 25 mM sodium borate, 2 mM CaCl₂, pH 9.0, twice with 25 mM Tris, 25 mM sodium borate, 2 mM CaCl₂, pH 9.0 and twice with 10 mM Tris, 25 mM sodium borate, 2 mM CaCl₂, pH 9.0, whereas bacitracin was washed five times with binding buffer. In each washing step 200 μl, buffer was added, the plate was incubated under vigorous shaking for 10 min at room temperature and the buffer was removed by vacuum.

To liberate the protease from the chromatographic medium, 200 μl elution buffer (50 mM sodium acetate, 2 mM CaCl₂, pH 4.8 for MEP-HyperCel and 75% binding buffer+1 M NaCl+25% isopropanol for bacitracin) was added and the filter plate was incubated at room temperature with vigorous shaking for 10 min. Elution buffer containing the protease was transferred by vacuum to a 96 well plate which for MEP-HyperCel had been added 50 μl storage buffer (0.5 M Mes, pH 7.0). Elution step was repeated by adding 200 μl elution buffer, shaking for 10 min at room temperature and collecting in another 96 well plate with 50 μl storage buffer for MEP-HyperCel. The micropurified protease variants were stored at −18° C.

Protease activities of culture broth, non-bound material from binding step and in eluates 1 and 2 were measured by mixing 10 μl protease containing sample with 90 μl assay buffer (0.1 M Tris, 0.0225% Brij 35, pH 8.6) and 100 μl substrate solution (0.4 mg/ml Suc-Ala-Ala-Pro-Phe-pNA in 0.1 M Tris, 0.0225% Brij 35, pH 8.6) and measuring absorbance at 405 nm for 3 minutes every 10 seconds. Activity was estimated by linear regression on initial, linear part of the curves.

Purity obtained by micropurification was estimated from SDS-PAGE. Proteins were precipitated with 1/3 volume of ice cold 50% TCA. Samples were incubated 30 min on ice and subsequently centrifuged. The pellets were resuspended in SDS sample buffer and 1 M Tris was added to increase pH above 9. 25 μl was loaded onto each lane of 4-20% (Novex) gel. For the crude culture supernatants several weak bands representing other proteins than the protease variants appeared as well as at least one strong band representing the protease variant. Samples obtained after eluation according to the present invention containing the purified protease variants only showed one strong band at the expected position. Purity after micropurification was for all 6 tested protease variants at least 90% as estimated from SDS-PAGE with both MEP-HyperCel and silica coupled bacitracin as chromatographic medium.

### Example 6

Use of Fluorescence for Concentration Determination of Micropurified Protease Variants

96 protease variants cloned into a Bacillus host were grown in a microtiter plate.

To each well of a filter plate (Whatman, Unifilter 800 μl, 25-30 μm MBPP) about 100 μl MEP-HyperCel slurry was added. 100 μl 0.5 M Ches, 25 mM sodium borate, 10 mM CaCl₂, pH 10.0 and 100 μl protease variant culture (2 times diluted with 0.1 M Ches, 2 mM CaCl₂, pH 9.5) was transferred to the wells of the filter plate. To bind the protease to the chromatographic medium, the filter plate was incubated 1 hour at room temperature with vigorous shaking (Heidolph, Titramax 101, 1200 rpm) to stir up the chromatographic medium. Cells and unbound material were transferred by vacuum (Whatman, UniVac 3) to a 96 well plate (collected to measure non-bound activity).

The chromatographic medium was washed once with 0.1 M Ches, 25 mM sodium borate, 2 mM CaCl₂, pH 9.5, twice with 25 mM Ches, 25 mM sodium borate, 2 mM CaCl₂, pH 9.5 and twice with 10 mM Ches, 25 mM sodium borate, 2 mM CaCl₂, pH 9.5. In each washing step 200 μl buffer was added, the plate was incubated under vigorous shaking for 10 min at room temperature and the buffer was removed by vacuum.

To liberate the protease from the chromatographic medium, 200 μl 50 mM sodium acetate, 2 mM CaCl₂, pH 4.8 was added and the filter plate was incubated at room temperature with vigorous shaking for 10 min. Elution buffer containing the protease was transferred by vacuum to a 96 well plate with 25 μl 0.5 M Mes, pH 7.0 added to each well. Elution step was repeated by adding 200 μl, elution buffer, shaking for 10 min at room temperature and collecting in another 96 well plate with 25 μl, 0.5 M Mes, pH 7.0 added. Eluate 1 and 2 were subsequently pooled.

Fluorescence was measured in 200 μl, of the pooled eluates using black microtiter plates with excitation at 280 nm and emission at 340 nm (PolarStar, BMG)(Offenburg).

Furthermore, protease concentrations in pooled eluates were determined by active site titration. 20 μl protease sample was mixed with 20 μl C₁₋₂A protease inhibitor of known concentration diluted in 0.1 M Tris, 0.0225% Brij 35, pH 8.6. Four inhibitor concentrations were used for each protease variant. After 1 hour incubation at room temperature, residual protease activity was measured by adding 160 μl 0.3 mg/ml Suc-Ala-Ala-Pro-Phe-pNA substrate in 0.1 M Tris, 0.0225% Brij 35, pH 8.6 and measuring absorbance at 405 nm every 10 seconds for 3 min. Residual activity as function of inhibitor concentration was extrapolated/interpolated to zero activity to give the protease concentration.

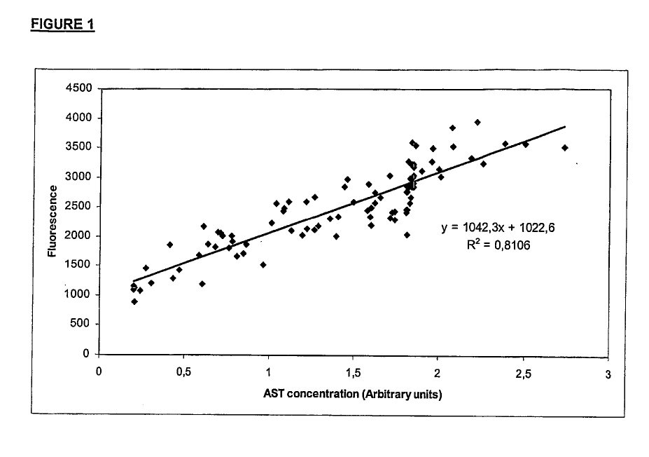

In FIG. 1, fluorescence is shown as function of concentration determined by active site titration. It is seen that a linear relation exists between these measurements and that a correlation coefficient of 0.81 was obtained (fluorescence=1042.3× protease concentration+1022.6, correlation coefficient=0.8106).

This shows that micropurification makes simple concentration determination by fluorescence measurement feasible. This is impossible with unpurified samples due to fluorescence from other components in the culture supernatants. With estimation of the protease concentration from fluorescence measurements using the linear relation in the figure below, calculated concentrations have a CV of 12% compared to concentrations determined by AST.

### Example 7

Micropurification of Protease Variants with Limiting Amount of Chromatographic Medium

Varying volumes of culture broths of twelve recombinant protease variants expressed in a Bacillus host were micropurified with limiting amount of chromatographic medium.

To each well of a filter plate (Whatman, Unifilter 800 μl, 25-30 μm MBPP) 10 μl MEP-HyperCel slurry was added. 100, 200 or 400 μl culture broth and ¼ of this volume 0.5 M Ches, 25 mM sodium borate, 10 mM CaCl₂, pH 10.0 were transferred to the wells of the filter plate. To bind the protease to the chromatographic medium, the filter plate was incubated 1 hour at room temperature with vigorous shaking (Heidolph, Titramax 101, 1200 rpm) to stir up the chromatographic medium. Cells and unbound material were transferred by vacuum (Whatman, UniVac 3) to a 96 well plate (collected to measure non-bound activity).

The chromatographic medium was washed once with 0.1 M Ches, 25 mM sodium borate, 2 mM CaCl₂, pH 9.5, twice with 25 mM Ches, 25 mM sodium borate, 2 mM CaCl₂, pH 9.5 and twice with 10 mM Ches, 25 mM sodium borate, 2 mM CaCl₂, pH 9.5. In each washing step 200 μl buffer was added, the plate was incubated under vigorous shaking for 10 min at room temperature and the buffer was removed by vacuum.

To liberate the protease from the chromatographic medium, 200 μl 50 mM sodium acetate, 2 mM CaCl₂, pH 4.8 was added and the filter plate was incubated at room temperature with vigorous shaking for 10 min. Elution buffer containing the protease was transferred by vacuum to a 96 well plate with 25 μl 0.5 M Mes, pH 7.0 added to each well.

Protease activities of eluates were measured by mixing 10 μl eluate with 90 μl assay buffer (0.1 M Tris, 0.0225% Brij 35, pH 8.6) and 100 μl substrate solution (0.4 mg/ml Suc-Ala-Ala-Pro-Phe-pNA in 0.1 M Tris, 0.0225% Brij 35, pH 8.6) and measuring absorbance at 405 nm for 3 minutes every 10 seconds. Activity was estimated by linear regression on initial, linear part of the curves.

In Table 1 below activities in eluates relative to eluate with 400 μl culture broth are given. If same fraction of protease activity was recovered for all three culture broth volumes, the relative activity with 100 μl broth would be expected to be 25% and with 200 μl broth the expected value would be 50%. However, the results in Table 1 show that much more similar results are obtained with the three different culture broth volumes. Thus, a significant decrease in expression variation can be obtained by using limiting amount of chromatographic medium for micropurification.

TABLE 1
Activity in eluates in % of activity obtained in eluates
from 400 μl culture broth.

| | Var1 | Var2 | Var3 | Var4 | Var5 | Var6 | Var7 | Var8 | Var9 | Var10 | Var11 | Var12 | Average | StDev |
|---|---|---|---|---|---|---|---|---|---|---|---|---|---|---|
| 100 μl broth | 62 | 87 | 77 | 59 | 63 | 40 | 91 | 65 | 99 | 79 | 122 | 84 | 77 | 22 |
| 200 μl broth | 76 | 100 | 93 | 83 | 77 | 92 | 99 | 90 | 132 | 86 | 91 | 94 | 93 | 14 |
| 400 μl broth | 100 | 100 | 100 | 100 | 100 | 100 | 100 | 100 | 100 | 100 | 100 | 100 | 100 | 0 |

### Example 8

Micropurification of Protease Variants with S-Sepharose as Chromatographic Medium

Culture broths of 8 protease variants cloned into a Bacillus host were micropurified using S-Sepharose as chromatographic medium.

To each well of a filter plate (Whatman, Unifilter 800 μl, 25-30 μm MBPP) 100 μl S-Sepharose chromatographic medium was added. 100 μl culture broth was diluted 15 times by adding 900 μl binding buffer (25 mM Tris, 10 mM sodium borate, 1 mM CaCl₂, pH 7.0) and 500 μl Milli Q water resulting in conductivities of about 2 mS/cm. Protease was bound to the chromatographic medium by repeating a binding step 3 times. In each step 500 μl diluted culture broth was added to each well of the filter plate, the filter plate was shaken vigorously (Heidolph, Titramax 101, 1200 rpm) for 15 min at room temperature, and cells and non-bound material were removed by vacuum (Whatman, UniVac 3).

Residual non-bound material was subsequently removed by washing 4 times with binding buffer. In each washing 200 μl binding buffer was added, the filter plate was shaken for 10 min, and the buffer was removed by vacuum.

To liberate the protease from the chromatographic medium, 200 μl-25 mM Ches, 10 mM sodium borate, 1 mM CaCl₂, 0.1 M NaCl, pH 10.0 was added and the filter plate was incubated at room temperature with vigorous shaking for 10 min. Elution buffer containing the protease was transferred by vacuum to a 96 well plate. Purity obtained by micropurification was estimated from SDS-PAGE. Proteins were precipitated with ⅓ volume of ice cold 50% TCA. Samples were incubated 30 min on ice and subsequently centrifuged. The pellets were resuspended in 25 μl SDS sample buffer and 1 M Tris was added to increase pH above 9. 25 μl was loaded onto each lane of 4-20% (Novex) gels. For each protease variant the culture supernatant as well as the eluate after purification according to the invention was loaded on the gels. Visual inspection of the gels showed that low molecular weight proteins and to some extent other proteins contained in the culture supernatant were removed.

1. A method of isolating tag-free biological compounds in a library comprising the steps of
(1) preparing a library of tag-free biological compounds,
(2) contacting, in solution, a population of discrete liquid samples comprising the library of tag-free biological compounds, each sample having a volume of less than 3.7 ml with a solid chromatographic material comprising a functional group selected from ion exchange materials, hydrophobic materials, affinity materials and hydrophobic charge induction materials so as to retain the tag-free biological compounds of the library on the solid chromatographic material,
(3) isolating the chromatographic material retaining the biological compounds of the library from the samples,
(4) releasing the biological compounds of the library from the solid chromatographic material and
(5) collecting the released biological compounds of the library to produce a population of samples comprising the isolated biological compound.

2. The method of claim 1, wherein the functional group of the chromatographic material is selected from diethyl aminoethyl, triethyl aminoethyl, trimethyl hydroxypropyl, quaternary aminomethyl, hydroxyapatite, carboxymethyl, orthophosphate, sulfonate, octyl groups, phenyl groups, antibodies, antigens, lectin, enzyme inhibitors, enzymes, receptors, messenger molecules, molecules comprising a mixture of L and D amino acids, ortho-nitrophenol and mercaptoethylpyridine.

3. The method of claim 1, wherein the discrete liquid samples are crude cell culture samples.

4. The method of claim 3, wherein the crude cell culture samples are contacted with the solid chromatographic material without any prior purification step.

5. The method of claim 4, wherein the cell culture is a bacterial cell culture.

6. The method of claim 1, wherein the library comprise at least 100 biological compounds.

7. The method of claim 1, wherein the biological compounds are selected from proteins, polypeptides, peptides, carbohydrates, lipids, glycopeptides, lipopeptides and glycolipids.

8. The method of claim 7, wherein the polypeptide is an enzyme.

9. The method of claim 8, wherein the enzyme is selected from the group consisting of muramidases, lysozymes, proteases, lipases, phospholipases, chitinases, glucanases, cellulases, peroxidases, or laccases.

10. The method of claim 1, wherein the isolation of the chromatographic material retaining the biological compounds is achieved by filtering the samples.

11. The method of claim 10, wherein the filtration is performed by applying a vacuum.

12. The method of claim 1, wherein the isolated chromatographic material retaining the biological compounds is subjected to one or more washing steps before releasing the biological compounds.

13. The method of claim 1, wherein the population of discrete liquid samples comprises at least 24 discrete samples.

14. The method of claim 13, wherein contacting of the discrete liquid samples and the solid chromatographic material is provided by means of a micro-titer plate.

15. The method of claim 14, wherein the micro-titer plate is equipped with filter bottoms.

16. The method of claim 15, wherein the micro-titer plate is equipped with a lid, which is in sealing contact with each compartment comprised in the plate.

17. The method of claim 16, wherein the sealing contact is provided by separate compartments such as a grid.

18. A method of screening a library of tag-free biological compounds for biological compounds with improved properties comprising isolating the biological compounds of the library in accordance with claim 1, testing at least one property of the isolated biological compounds of the library and selecting biological compounds having at least one improved property.

19. The method of claim 18, wherein the improved property tested is selected from stability in detergents, thermal stability, chemical stability, pH stability, specific activity, in vivo half-life in animal including man, toxicity in an animal including man and immunogenicity in animals including man.

20. A kit for isolating tag-free biological compounds of a library comprising
(1) a population of at least 24 containers, having a volume of 3.7 ml or less, capable of holding a population of discrete liquid samples comprising a library of tag-free biological compounds,
(2) means for mixing the liquid samples with a solid chromatographic material comprising a functional group selected from ion exchange materials, hydrophobic materials, hydrophobic charge induction materials and affinity materials so as to retain the tag-free biological compounds of the library on the chromatographic material,
(3) means for separating the tag-free biological compounds of the library retained on the chromatographic material from the liquid sample,
(4) means for releasing the tag-free biological compounds of the library from said solid chromatographic material and
(5) means for recovering the released tag-free biological compounds.

21. A kit for screening a library of tag-free biological compounds for biological compounds having at least one improved property comprising the kit of claim 20, means for testing at least one property of the biological compounds of the library and means for selecting biological compounds having an improved property.
